(19) United States
(12) Patent Application Publication
(10) Pub. No.: US 2016/0078182 A1
(43) Pub. Date: Mar. 17, 2016

(54) Using Toxicity Level in Treatment Recommendations by Question Answering Systems

(71) Applicant: International Business Machines Corporation, Armonk, NY (US)

(72) Inventors: Corville O. Allen, Morrisville, NC (US); Roberto DeLima, Apex, NC (US); Thomas J. Eggebraaten, Rochester, MN (US); Andrew R. Freed, Cary, NC (US); Mark G. Megerian, Rochester, MN (US); Marie L. Setnes, Bloomington, MN (US)

(21) Appl. No.: 14/487,532

(22) Filed: Sep. 16, 2014

(51) Int. Cl. G06F 19/00

(52) U.S. Cl. CPC G06F 19/345; G06F 19/3431

(57) ABSTRACT

Mechanisms are provided for outputting a treatment recommendation for a medical malady. The mechanisms receive an input specifying a medical malady of a specified patient and determine one or more constituent agents of a potential treatment for the specified medical malady of the specified patient. The mechanisms retrieve a treatment toxicity profile corresponding to the medical malady. In addition, the mechanisms calculate a treatment toxicity score for the potential treatment based on a comparison of patient medical attributes of the specified patient to toxicity criteria associated with the one or more constituent agents identified in the treatment toxicity profile. The mechanisms then output a treatment recommendation based on the treatment toxicity score.

### BACKGROUND

The present application relates generally to an improved data processing apparatus and method and more specifically to mechanisms for utilizing toxicity level evaluations when recommending treatments using a question answering system.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

Examples, of QA systems are Siri® from Apple®, Cortana® from Microsoft®, and the Watson™ system available from International Business Machines (IBM®) Corporation of Armonk, N.Y. The Watson™ system is an application of advanced natural language processing, information retrieval, knowledge representation and reasoning, and machine learning technologies to the field of open domain question answering. The Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

### SUMMARY

In one illustrative embodiment, a method, in a data processing system comprising a processor and a memory, for outputting a treatment recommendation for a medical malady is provided. The method comprises receiving, by the data processing system, an input specifying a medical malady of a specified patient and determining, by the data processing system, one or more constituent agents of a potential treatment for the specified medical malady of the specified patient. The method further comprises retrieving, by the data processing system, a treatment toxicity profile corresponding to the medical malady. In addition, the method comprises calculating, by the data processing system, a treatment toxicity score for the potential treatment based on a comparison of patient medical attributes of the specified patient to toxicity criteria associated with the one or more constituent agents identified in the treatment toxicity profile. The data processing system outputs a treatment recommendation based on the treatment toxicity score.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a question/answer creation (QA) system in a computer network;

FIG. 2 is a block diagram of an example data processing system in which aspects of the illustrative embodiments are implemented;

FIG. 3 illustrates a QA system pipeline for processing an input question in accordance with one illustrative embodiment;

FIG. 4 is an example diagram illustrating a treatment toxicity profile in accordance with one illustrative embodiment;

FIG. 5 is an example block diagram outlining an operation of a toxicity scoring engine in accordance with one illustrative embodiment;

FIG. 6 is a flowchart outlining an example operation of a question answering system in accordance with one illustrative embodiment; and

FIG. 7 is a flowchart outlining an example operation of a toxicity scoring engine in accordance with one illustrative embodiment.

### DETAILED DESCRIPTION

Question Answering (QA) systems are being introduced into the healthcare industry to aid medical professionals in the diagnosis and treatment of patients. Specially trained using sets of training questions directed to healthcare related domains, and using corpora combining medical knowledge and resources from various sources, these QA systems are able to answer posed questions quickly and in most cases with high accuracy. Using a QA system, a user is able to ask questions about symptoms, diseases, drugs, treatment regimens, and a host of other healthcare related topics.

While QA systems provide a valuable resource for medical professionals, there currently are some limitations to what the QA systems are able to provide. One current challenge is that the number of potential medical conditions of patients, interactions between medical conditions of patients, drug effects, toxicity information for drugs, interactions of drugs with one another, treatment options combining drugs and other treatments, and the like, cause medical logic implemented in QA systems to be more complex and sensitive to changes. Adding to this, there is no current standardized way of inferring how well a patient can tolerate a particular treatment, e.g., drug or combination of drugs, radiation, or any other treatment alone or in combination with other treatments. Furthermore, it is very difficult to scale medical logic as more comprehensive coverage is introduced, i.e. using a small set of treatment options, the logic of the QA system is manageable, however as the number of treatment options increases the logic becomes very complex and hard to manage.

To address some of these issues, the illustrative embodiments provide a toxicity scoring mechanism that may be used in, or in association with, a QA system, to evaluate the candidate answers specifying a treatment option for a particular patient. The toxicity scoring mechanism evaluates the toxicity of a particular treatment option with regard to a particular patient's ability to tolerate the toxicity of the treatment as well as the patient's preferences regarding whether or not the patient wants to tolerate a particular level of toxicity in exchange for a particular or probability of beneficial result of the treatment, e.g., expected likelihood of cure, reduction in symptoms, or the like. The toxicity scoring mechanisms of the illustrative embodiments determine and apply toxicity levels in treatment recommendations for patients based on compiled toxicity information for the treatment and patient personal medical information. With these mechanisms, it is assumed that the treatments/drugs being considered have well-understood toxicities and that the toxicity information is readily available and up to date in the QA system. The toxicity information may be obtained from various sources include, for example, electronically stored or manually input Food and Drug Administration (FDA) label information, medical journals stored electronically, electronically stored medical text books and/or drug reference texts, drug/treatment manufacturer/developer websites, hospital documentation, or any other suitable source of information regarding drugs, treatments, surgical procedures, or the like. It should be noted that the term “treatment” as it is used herein may refer to drug treatments, surgical treatments, physical therapy, radiation treatments, a combination of a plurality of drugs, a combination of surgical treatments, a combination of physical therapy treatments, or a combination of a plurality of these types, e.g., a combination of one or more drugs with one or more surgical procedures. Any medical treatment is intended to be within the spirit and scope of the illustrative embodiments and encompassed within the use of the term “treatment” or “medical treatment” herein and in the appended claims.

The assumption of readily available and up to date treatment toxicity information is primarily for safety concerns and to ensure that sufficient and reliable toxicity information is utilized in the analysis performed by the QA system. It should be appreciated that checks may be periodically made by the QA system to ensure that the toxicity information is not stale, e.g., older than a predetermined threshold, and if so, updating the toxicity information automatically by searching and compiling the toxicity information from one or more of the sources noted above to ensure that the QA system is operating with the most up-to-date toxicity information. If the QA system is unable to update the toxicity information for a particular treatment for any reason, the treatment may temporarily, or permanently, be removed from consideration by the QA system until the toxicity information is able to be updated to within the staleness criteria. A notification may be sent to an administrator in such a situation so as to cause the administrator to get involved in updating the toxicity information through a manual or semi-manual process.

It should be appreciated that the QA system of the illustrative embodiments is not limited to only considering well established treatments with well established toxicity information. In some illustrative embodiments, less reliable toxicity information, such as information obtained through medical trials or the like, could also be used with appropriate treatment of this information due to its nature and lower reliability. In such embodiments, the reliability of the toxicity information may be evaluated in association with patient preferences indicating whether or not the patient wishes to consider such treatments and the level of reliability the patient prefers when considering such treatments. Thus, for example, a patient may state that they are willing to consider treatments that have toxicity information that is 65% reliable in which case certain medical trials whose toxicity information is only 50% reliable may be removed from consideration. Even in the case where a patient has indicated a desire to consider such less reliable toxicity information treatments, if such a treatment option is returned as a potential recommended treatment, clear warning messages may be output in association with these treatment recommendations with less reliable toxicity information, e.g., less than a threshold reliability, e.g., 95% reliable, in order to make sure that the physician is aware of the risks involved.

As touched upon above, the QA system is configured under the assumption that the degree of acceptable toxicity may vary by disease or malady. Moreover, it is assumed that patients have varying degrees of tolerance to a particular treatment based on comorbidities or other conditions. Thus, the QA system seeks to identify the acceptable level of toxicity for a particular patient taking into consideration the varying degree of acceptable toxicity and individual patient tolerance to the toxicity of the particular treatment options, as well as individual patient preferences regarding the level of toxicity they are willing to endure. The end goal of the QA system is to provide answers to questions directed to treatments for diseases and maladies that identify the best treatment that the particular patient can tolerate taking into account the toxicities of the treatments and comorbidities and other conditions.

The illustrative embodiments provide mechanisms used in, or in association with, a QA system to score toxicity of a treatment based on the types of agents (drugs, radiation, surgery, etc.) used in the treatment, the patient's current attributes and medical history information, and the associated adverse events, side effects, or the like, that can occur in patients receiving a particular treatment, e.g., drug or set of drugs, such as nausea, bleeding, renal failure, etc. Thus, the solution provided by the illustrative embodiments takes into account drug labeled side effects, the level of toxicity acceptable by the treatment plan, and the patient's degree of tolerance as well as patient preferences. The toxicity score is then used to rank and select a suitable treatment for the particular patient. The QA system may further provide evidential support and reasoning that may be viewed by the user so that the user may gain a greater understanding as to why a particular treatment option is selected for the particular patient.

For purposes of the description of the illustrative embodiments, it will be assumed that the mechanisms of the illustrative embodiments are being utilized to provide treatment recommendations for oncology patients based on toxicity information for various drug/surgical/radiation treatment plans as well as patient medical records and preferences. However, even though this is being used as an example implementation for descriptive purposes, the present invention is not limited to such. Rather, the mechanisms of the illustrative embodiments may be used with regard to any medical or psychological condition for which treatment recommendations are sought. For example, the mechanisms of the illustrative embodiments may be used to provide treatment recommendations for particular forms of learning disorders, particular dental conditions, particular internal injuries to a patient, or the like. Any medical or psychological condition for which the toxicity of a treatment plan to a patient is of concern may be the subject of the mechanisms of the illustrative embodiments.

In operation, the mechanisms of the illustrative embodiments involve the definition of a toxicity tolerance profile for treatments of a particular disease or malady based on a set of potential patient attributes (e.g., comorbidities, age, performance status, status indicators for patient overall health, such as an Eastern Cooperative Oncology Group (ECOG) score or the like, etc.) and treatment agents or treatment agent combinations, with inclusion, exclusion, and gradient values for each treatment agent, or combination, being provided in association with the corresponding potential patient attributes. For example, for a particular disease or malady, e.g., “lung cancer,” a toxicity tolerance profile may be established with a plurality of patient attributes including hearing grade, cardiac disease grade, creatinine clearance, bilirubin level, patient age, etc. For each potential treatment agent or combination of agents, toxicity criteria may be established for indicating the measure of toxicity to patients exhibiting the various patient attributes set forth in the toxicity tolerance profile. The toxicity criteria may specify either concern for the toxicity of the treatment to a patient having a particular patient attribute, value of patient attribute, or the like, criteria indicating safety of the treatment for a patient in view of the toxicity of the treatment for the particular patient attribute, value of the patient attribute, or the like, or a combination of safety and concern toxicity criteria.

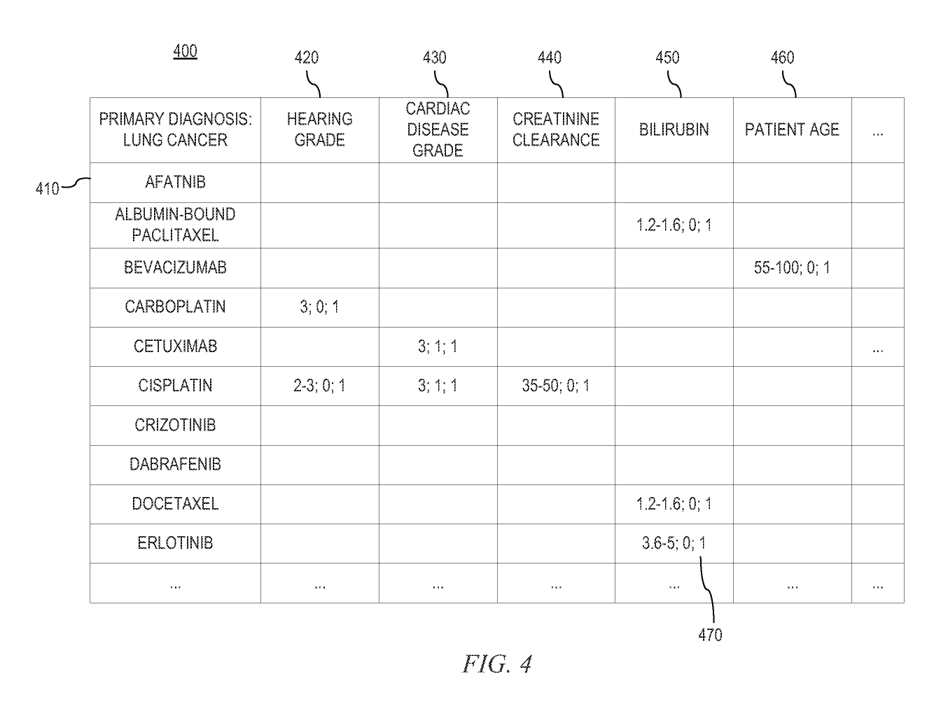

For example, as will be discussed in more detail hereafter with reference to FIG. 4, for a diagnosis of “lung cancer” among the various potential treatments is a drug treatment using the drug Cisplatin. In the toxicity tolerance profile for “lung cancer,” an entry for the drug Cisplatin may be provided in which various criteria are set forth for the various potential patient attributes. Thus, for example, a patient attribute of “hearing grade” may be provided in the toxicity tolerance profile and an associated range of concern of “2-3” may be established in association with the drug Cisplatin and hearing grade. Thus, this essentially states that there is a concern with treating lung cancer patients with Cisplatin if the lung cancer patient has a hearing grade in the range of 2-3. Similarly, another patient attribute may be a “cardiac disease grade” and a value of “3” may be established for this patient attribute in association with the drug Cisplatin. In such a case, this means that lung cancer patients that have a cardiac disease grade of 3 may have a toxicity risk if treated with Cisplatin. Other illustrative embodiments, rather than using exclusionary ranges, gradients, and/or values, may utilize inclusive ranges, gradients, and/or values to specify values that would indicate that the patient should be treated with the corresponding treatment option. Additional criteria may be provided for each potential treatment and patient attribute as will be described in greater detail hereafter.

The toxicity tolerance profile may be generated manually, automatically, or by way of a combined manual and automated methodology. In one illustrative embodiment, a corpus of documentation is searched and analyzed to compile a listing of the various treatments, for various diseases or maladies, and their associated toxicity information. For example, the FDA may establish toxicity information for various drugs and/or treatment plans which correlate patient attributes with quantitative values indicative of safety/concern for the treatment. The same is true of other documentation from other sources including medical journals, drug reference texts, medical trial documentation, drug/treatment developers and manufacturers, and the like. This information may be automatically parsed and analyzed using natural language processing or other structure/unstructured parsing and analysis techniques such that the information is compiled into the toxicity tolerance profile.

The toxicity tolerance profile is used along with particular patient medical information to determine the treatments in the toxicity tolerance profile that are appropriate for recommendation for the particular patient. That is, the particular values associated with patient attributes specified in a data structure for the particular patient are compared against the toxicity criteria specified in the toxicity tolerance profile to determine which treatment options are available to the particular patient. Each element of a treatment plan, or treatment option, may have their own toxicity score generated for that particular element (each element of a treatment plan or option is referred to herein as an “agent” of the treatment). Thus, for example, a treatment plan or option may specify a plurality of drugs to be administered to the patient. These drugs may have many different adverse affects or side effects on a patient depending on the particular makeup of the drug and the particular attributes of the patient. Moreover, these drugs may have adverse affects due to interactions of the drugs themselves. This information, for each such drug in the treatment plan or option, is specified in the toxicity tolerance profile and is compared to the particular patient's medical information to determine an agent score for the particular agent, i.e. the drug. A separate agent score may be generated for each agent in the particular treatment plan or option and this process may be repeated for each treatment plan or option being considered for the particular patient.

A treatment plan or options' toxicity score is then generated for each particular treatment plan or option by combining the agent scores for the various elements of the treatments being considered, e.g., the various drugs, surgical procedures, radiation treatments, or the like. The treatment option's toxicity score may then be compared against patient preferences to determine if the treatment option falls within the scope of preferences, or a sub-scope, of the preferences of the particular patient. Alternatively, or in addition, the preferences of the patient may be utilized when generating agent scores by utilizing the patient preferences as another factor in the calculation of the agent score.

Based on the treatment plan/option toxicity scores, a ranked listing of treatment plans/options for the particular patient may be generated. The ranked listing may rank the treatment plans/options according to levels of toxicity with the least toxic treatment plans/options being listed with higher priority than other possible treatment plans/options. Reasoning for the toxicity scores of the treatment plans/options may be associated with each of the ranked treatment plans/options so that this reasoning may be drilled down into by the user to determine the reasoning behind why the treatment plan/option is considered toxic, in what ways, the risks involved, the patient attributes leading to the toxicity score, and other information that may be pertinent to a determination as to whether or not to adopt a particular treatment plan/option. A final treatment plan/option output may also be generated from the ranked listing indicating the treatment plan/option that is determined to be the best option for the particular patient.

The final treatment plan/option and/or the ranked listing of the treatment plans/options may be output to the user for consideration. The output may be in the form of a graphical user interface with graphical user interface elements providing mechanisms for the user to drill down from the ranked listing into the underlying evidence data supporting the toxicity scoring of the treatment plans/options. Thus, a user may submit a request for information regarding treatment plans/options for a particular patient and may be presented with a recommended treatment plan/option and/or a ranked listing of treatment plans/options with their associated toxicity scores and underlying reasoning as to why the treatment plan/option is recommended and the basis for the determination of the toxicity level of the treatment plan/option and its agents. Hence, users are given a greater understanding as to why treatment plans/options are selected and recommended while taking into consideration the large number of toxicity characteristics of the treatment plans/options and their agents in correlation with the particular patient attributes of the patient for which a treatment plan/option is requested.

Before beginning a more detailed discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the toxicity scoring mechanisms of the illustrative embodiments may be implemented in, or in association with, a Question Answering (QA) system, such as the IBM Watson™ QA system available from International Business Machines (IBM) Corporation of Armonk, N.Y. Such a QA system is preferably trained on, and utilizes, one or more corpora of information, e.g., electronic documents, websites, information databases, knowledge bases of various types, portions of text such as postings to websites, instant messages, or the like. This training, in the context of a medical treatment toxicity scoring and treatment plan recommendation system, is preferably performed in one or more medical domains, e.g., oncology or the like. Through training, a set of questions for which answers are known are submitted to the QA system which then operates on the one or more corpora to generate candidate answers and their corresponding confidence scores. The candidate answers are ranked and merged according to the confidence scores and supporting evidence for the candidate answer and a final ranked listing of one or more candidate answers is generated. The candidate answers are compared to the known correct answers to the input questions and adjustments are made to the operation of the QA system to improve the operation of the QA system with regard to the candidate answers generated by the QA system. This is an iterative process that results in multiple adjustments to the QA system operation over time to achieve increasingly better results.

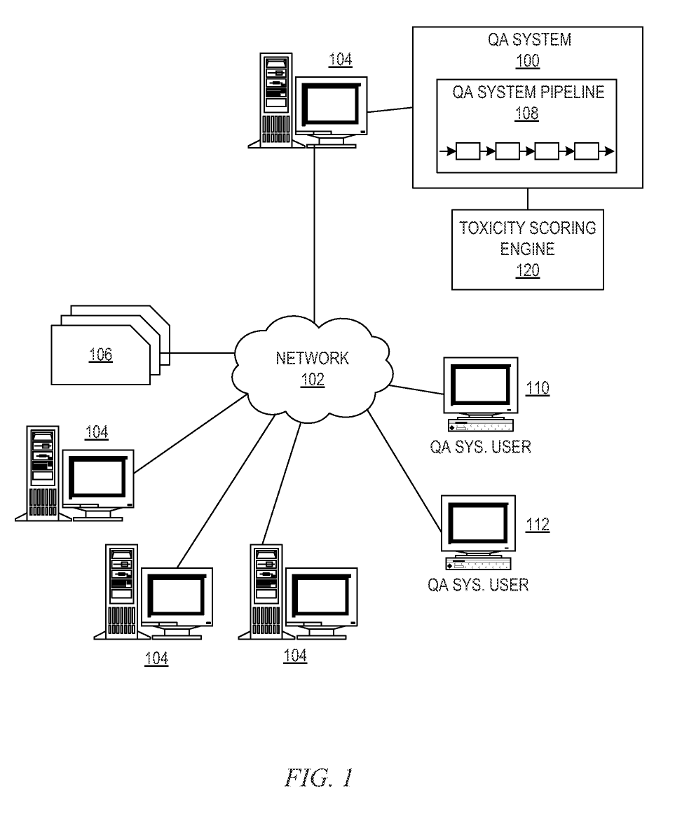

In order to provide a context for the description of the specific elements and functionality of the illustrative embodiments with regard to the integration or association of a toxicity scoring mechanism in a QA system, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example Question Answering (QA) system (also referred to as a Question/Answer system or Question and Answer system), methodology, and computer program product with which the mechanisms of the illustrative embodiments are implemented. As will be discussed in greater detail hereafter, the illustrative embodiments are integrated in, augment, and extend the functionality of these QA mechanisms with regard to toxicity scoring and treatment plan/option ranking for particular patient attributes and preferences in order to generate a recommended treatment plan/option for the particular patient.

Thus, it is important to first have an understanding of how question and answer creation in a QA system is implemented before describing how the mechanisms of the illustrative embodiments are integrated in and augment such QA systems. It should be appreciated that the QA mechanisms described in FIGS. 1-3 are only examples and are not intended to state or imply any limitation with regard to the type of QA mechanisms with which the illustrative embodiments are implemented. Many modifications to the example QA system shown in FIGS. 1-3 may be implemented in various embodiments of the present invention without departing from the spirit and scope of the present invention.

As an overview, a Question Answering system (QA system) is an artificial intelligence application executing on data processing hardware that answers questions pertaining to a given subject-matter domain presented in natural language. The QA system receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA system. The document may include any file, text, article, or source of data for use in the QA system. For example, a QA system accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to the QA system which then answers the input questions using the content in the corpus of data by evaluating documents, sections of documents, portions of data in the corpus, or the like. When a process evaluates a given section of a document for semantic content, the process can use a variety of conventions to query such documents from the QA system, e.g., sending the query to the QA system as a well-formed question which are then interpreted by the QA system and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA system receives an input question, parses the question to extract the major features of the question, uses the extracted features to formulate queries, and then applies those queries to the corpus of data. Based on the application of the queries to the corpus of data, the QA system generates a set of hypotheses, or candidate answers to the input question, by looking across the corpus of data for portions of the corpus of data that have some potential for containing a valuable response to the input question. The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model is used to summarize a level of confidence that the QA system has regarding the evidence that the potential response, i.e. candidate answer, is inferred by the question. This process is repeated for each of the candidate answers until the QA system identifies candidate answers that surface as being significantly stronger than others and thus, generates a final answer, or ranked set of answers, for the input question.

As mentioned above, QA systems and mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA system to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA system. Content creators, automated tools, or the like, annotate or otherwise generate metadata for providing information useable by the QA system to identify these question and answer attributes of the content.

Operating on such content, the QA system generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a question/answer creation (QA) system 100 in a computer network 102. One example of a question/answer generation which may be used in conjunction with the principles described herein is described in U.S. Patent Application Publication No. 2011/0125734, which is herein incorporated by reference in its entirety. The QA system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The QA system 100 and network 102 enables question/answer (QA) generation functionality for one or more QA system users via their respective computing devices 110-112. Other embodiments of the QA system 100 may be used with components, systems, sub-systems, and/or devices other than those that are depicted herein.

The QA system 100 is configured to implement a QA system pipeline 108 that receive inputs from various sources. For example, the QA system 100 receives input from the network 102, a corpus of electronic documents 106, QA system users, and/or other data and other possible sources of input. In one embodiment, some or all of the inputs to the QA system 100 are routed through the network 102. The various computing devices 104 on the network 102 include access points for content creators and QA system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the QA system 100 may operate in environments of any size, including local and global, e.g., the Internet.

In one embodiment, the content creator creates content in a document of the corpus of data 106 for use as part of a corpus of data with the QA system 100. The document includes any file, text, article, or source of data for use in the QA system 100. QA system users access the QA system 100 via a network connection or an Internet connection to the network 102, and input questions to the QA system 100 that are answered by the content in the corpus of data 106. In one embodiment, the questions are formed using natural language. The QA system 100 parses and interprets the question, and provides a response to the QA system user, e.g., QA system user 110, containing one or more answers to the question. In some embodiments, the QA system 100 provides a response to users in a ranked list of candidate answers while in other illustrative embodiments, the QA system 100 provides a single final answer or a combination of a final answer and ranked listing of other candidate answers.

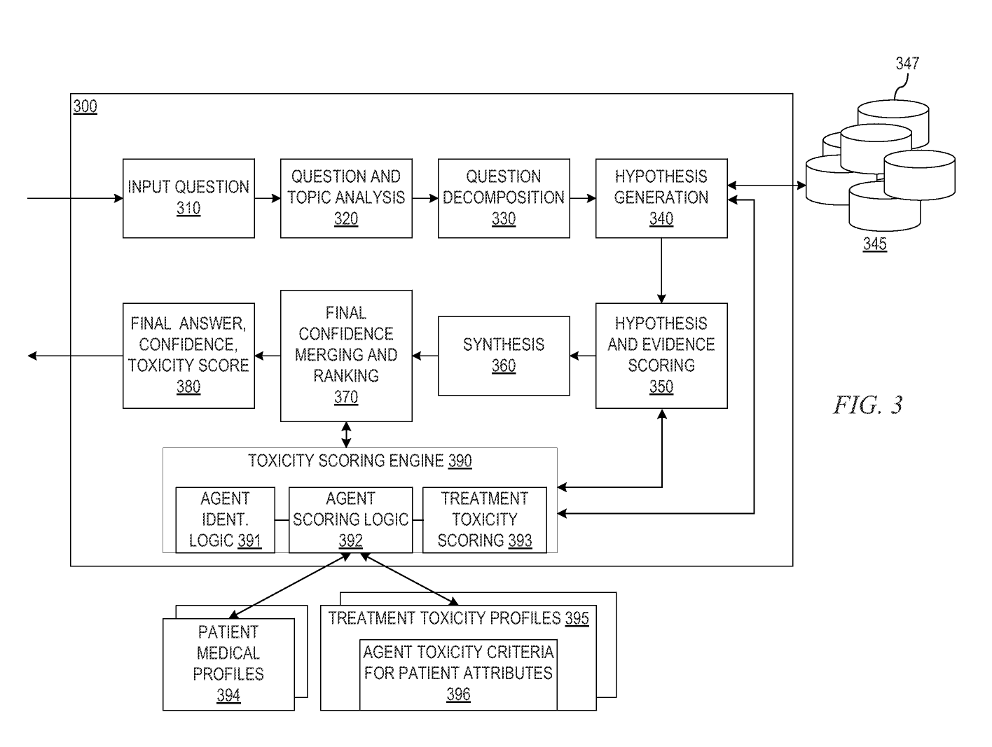

The QA system 100 implements a QA system pipeline 108 which comprises a plurality of stages for processing an input question and the corpus of data 106. The QA system pipeline 108 generates answers for the input question based on the processing of the input question and the corpus of data 106. The QA system pipeline 108 will be described in greater detail hereafter with regard to FIG. 3.

In some illustrative embodiments, the QA system 100 may be the IBM Watson™ QA system available from International Business Machines Corporation of Armonk, N.Y., which is augmented with the mechanisms of the illustrative embodiments described hereafter. As outlined previously, the IBM Watson™ QA system receives an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The IBM Watson™ QA system then performs deep analysis on the language of the input question and the language used in each of the portions of the corpus of data found during the application of the queries using a variety of reasoning algorithms. The scores obtained from the various reasoning algorithms are then weighted against a statistical model that summarizes a level of confidence that the IBM Watson™ QA system has regarding the evidence that the potential response, i.e. candidate answer, is inferred by the question. This process is repeated for each of the candidate answers to generate a ranked listing of candidate answers which may then be presented to the user that submitted the input question, or from which a final answer is selected and presented to the user. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

With particular relevance to the mechanisms of the illustrative embodiments, the QA system 100 in FIG. 1 may be configured, through training, to answer questions regarding treatment of one or more types of diseases or medical maladies. In doing so, the QA system 100 may be associated with, or have integrated therein, a toxicity scoring engine 120 that utilizes toxicity information for various treatments and agents of treatments, as well as patient medical profile information, to determine the best treatment options for a patient based on toxicity tolerance. The toxicity scoring engine 120 may take the candidate answers generated by the QA system 100 and evaluate them based on toxicity information and patient medical profile information to refine the candidate answers according to toxicity tolerance and generate a toxicity based ranking of candidate answers. This toxicity based ranking of candidate answers may be used to influence the final merge of candidate answers to thereby generate a final ranked listing of candidate answers and ultimately a recommended answer to the original question posed to the QA system. In the context of a medical treatment plan, the original input question is assumed to be of the type that requests a recommendation for a treatment plan for a particular disease or medical malady of a particular patient, as described hereafter.

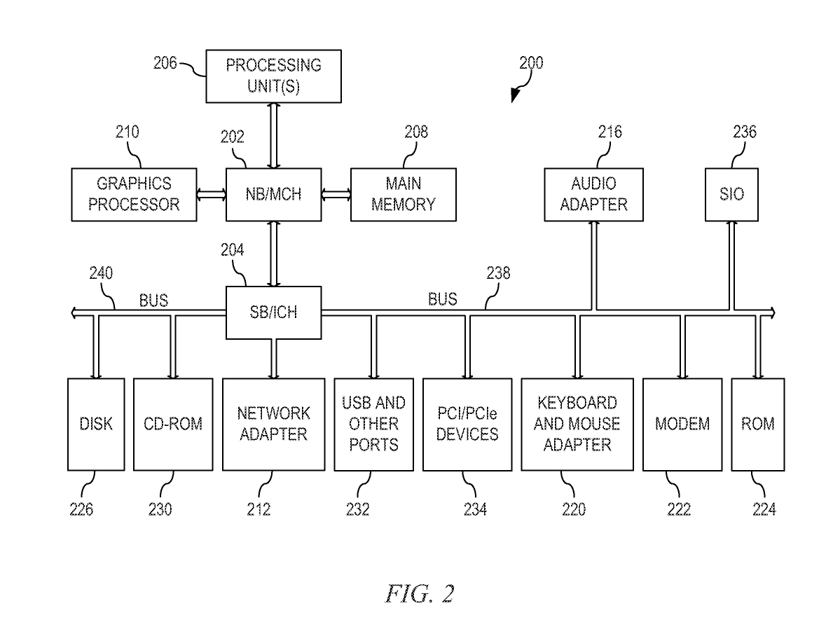

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a QA system 100 and QA system pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System P® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates a QA system pipeline for processing an input question in accordance with one illustrative embodiment. The QA system pipeline of FIG. 3 may be implemented, for example, as QA system pipeline 108 of QA system 100 in FIG. 1. It should be appreciated that the stages of the QA system pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA system pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA system pipeline 300 comprises a plurality of stages 310-380 through which the QA system operates to analyze an input question and generate a final response. In an initial question input stage 310, the QA system receives an input question that is presented in a natural language format. That is, a user inputs, via a user interface, an input question for which the user wishes to obtain an answer, e.g., “Who are Washington's closest advisors?” In response to receiving the input question, the next stage of the QA system pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA system pipeline 300, in stage 350, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA system and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA system that identifies a manner by which these scores may be combined to generate a confidence score or measure for the individual hypotheses or candidate answers. This confidence score or measure summarizes the level of confidence that the QA system has about the evidence that the candidate answer is inferred by the input question, i.e. that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

The above description of FIG. 3 provides a general overview of a QA system pipeline 300 which may be used with the mechanisms of the illustrative embodiments. It should be appreciated that, in accordance with the illustrative embodiments, the QA system pipeline 300 is configured to provide treatment recommendations for patients in a medical domain. For example, the corpus 347 or corpora 345 upon which the QA system pipeline 300 operates may be specifically configured to include documents and sources of information chosen from one or more medical domains, e.g., oncology, epidemiology, or any other medical domain. The corpus 347 or corpora 345 may comprise information from various sources includes FDA databases, electronic documents representing medical texts, drug reference texts, medical journals, medical trial documentation, or any other suitable source of medical knowledge that provides information indicative of treatment plans and treatment agents as well as their toxicity information.

Moreover, the various stages 310-380 of the QA system pipeline 300 may be configured for use in performing their operations with regard to medical terminology, medical features, and the like, of the particular domain(s) for which the QA system pipeline 300 is configured. It should be appreciated that a QA system may comprise a plurality of such QA system pipelines 300 which may each be individually configured for different domains and may operate using differently configured corpora 345 and toxicity scoring engines 390. For purposes of the following description, it will be assumed that the QA system pipeline 300 is configured for answering questions directed to the medical domain of oncology. As such, the input question 310 may be of the type requesting information about medical treatments for various types of cancer and specifically a type of cancer associated with a particular identified patient. For example, the input question 310 may be for a particular patient, what are the recommended treatments for a diagnosis of the patient having lung cancer. The input question 310 may thus, have not only the text of the question itself, but may include an identifier of the patient in the question or associated with the question, e.g., “What are the recommended treatments of lung cancer for patient 123456?” or “What are the recommended treatments for John Smith?” and an associated link being provided to the John Smith's patient medical profile 394.

In such a scenario, the QA system pipeline 300 may operate in much the same manner as already described above by analyzing the question and topic, decomposing the question into queries applied to the corpus 347 or corpora 345, generating hypothesis information formation, and providing an initial scoring of the hypothesis (or candidate answers) with regard to confidence and evidentiary support for the candidate answer, i.e. the operations outlined in stages 320-350 in FIG. 3. The candidate answers generated as part of the hypothesis generation 340 indicate treatment options for the disease/medical malady specified in the input question or otherwise identified in the patient medical profile 394 of the patient identified in the input question 310. For example, if the input question is of the type “What treatments are recommended for John Smith?” then the QA system pipeline 300 may, in stage 320 or 330 when analyzing the question and decomposing the question, retrieve the corresponding patient medical profile for the identified patient, identify the current medical diagnosis for the patient and use this current medical diagnosis as a basis for generating queries against the corpus 347 or corpora 345, and obtain candidate answers indicative of the treatments for the particular medical diagnosis.

The candidate answers indicating various possible treatment plans or options for the particular identified patient are provided to the toxicity scoring engine 390 which then scores the candidate answers according to a determined toxicity of the agents of the treatment plans or options and the overall treatment plan/option as a whole. This scoring takes into consideration the tolerance of the particular patient to the toxicity of the treatment agents and treatment plan/option as a whole, as may be determined from the toxicity criteria associated with the agents of the treatment plan/option and the patient's attributes, as well as the patient's preferences for tolerating certain types and levels of toxicity. The toxicity scoring engine 390 includes treatment agent identification logic 391, treatment agent scoring logic 392, and treatment toxicity scoring logic 393, as well as additional logic within the toxicity scoring engine 390 to coordinate the operation of the logic 391-393 and orchestrate their operation to implement the operations for toxicity scoring and treatment recommendation in accordance with the illustrative embodiments.

The agent identification logic 391 takes each candidate answer (or hypothesis) identified by the hypothesis generation stage 340 and analyzes the candidate answer to identify the agents that are part of the treatment plan or option specified in the candidate answer. Such analysis may involve other data structures (not shown), which identify for a particular treatment plan/option what agents are part of that treatment plan/option, e.g., treatment plan A for lung cancer involves drugs X, Y, and Z as well as surgical procedure W. In this way, the agent identification logic 391 separates out the treatment plan/option specified in a candidate answer into its constituent agents.

The treatment agent scoring logic 392, for each agent identified by the agent identification logic 391, retrieves a corresponding treatment toxicity profile 395 for the particular disease or medical malady being asked about, e.g., lung cancer, and treatment plan/option. The treatment toxicity profile 395 includes agent toxicity criteria for different agents of the treatment plan/option for various potential patient attributes. The agent scoring logic 392 further retrieves patient medical profile 394 for the patient in question as identified in the input question 310. The patient medical profile 394 preferably stores information regarding the patient's current and historical medical condition including previous and current diagnosis by a physician, laboratory analysis (e.g., bilirubin levels, thyroid measurements, etc.), medical attributes (blood pressure, age, whether the patient is a smoker, drinks alcohol, weight, height, etc.), and other medical information that identifies patient attributes and may be important to consider when determining a treatment plan for the particular patient. The agent scoring logic 392 correlates the information in the patient medical profile 394 with the agent toxicity criteria 396 in the treatment toxicity profile 395 and generates a toxicity score for the agent.

For example, if the patient has been diagnosed with lung cancer, and the input question 310 identifies the patient and asks what the recommended treatment is for the particular patient with regard to lung cancer, the treatment toxicity profile 395 may comprise a data structure for lung cancer with one or more entries for different treatment plans for treating lung cancer. Each treatment plan may comprise one or more agents and corresponding agent toxicity criteria correlated with potential patient attributes. For example, a treatment plan may comprise administering a drug “Cisplatin” and this drug may have toxicity criteria associated with one or more potential patient attributes including, but not limited to, hearing grade, cardiac disease grade, creatinine clearance, bilirubin levels, patient age, etc. Each toxicity criteria may be specified in terms of a range or gradient of values, an explicit fixed value, or the like. The range, gradient, or fixed values may be indicative of inclusiveness in the use of the treatment or exclusiveness in the use of the treatment, e.g., if the patient's hearing grade is within the range specified in the toxicity criteria, then the patient should be included for treatment with the drug or if the patient's hearing grade is within the range specified in the toxicity criteria, then the patient should be excluded from treatment with the drug.

Weighting values may be associated with these determinations as well rather than using a rigid inclusion/exclusion determination. That is, one or more values may be associated with the determination based on a relative match of the patient's actual attribute value to the toxicity criteria. For example, if the patient's actual attribute value is near a high end of a range of toxicity criteria, the weighting value may be relatively lower or higher depending on the type of evaluation being performed, e.g., higher value if the attribute is indicative of a lower toxicity or risk to the patient. For example, for the drug “Cisplatin” a toxicity criteria may be specified with regard to a creatinine clearance patient attribute that if the patient's creatinine clearance value is in the range of 35-50, the patient should be excluded from consideration for treatment with Cisplatin in accordance with a gradient corresponding to the range. For example, the lower the creatinine clearance score, the less likely Cisplatin is going to be used. With a score of 51 or higher, there is no toxicity and it is fine to use Cisplatin to treat the patient for lung cancer. Starting at 50 there is a small exclusion, which may be measured together with other exclusions/inclusions for other drugs or treatment agents so as to generate an overall determination of inclusion/exclusion for the treatment in terms of a toxicity score for the treatment. For example, the exclusion of Cisplatin may become a moderate exclusion at a creatinine clearance of 42 and a strong exclusion at 35. Anything lower than 35 is fully excluded. Different weighting values may be associated with these different toxicity criteria so as to represent the “weak”, “moderate”, and “strong” exclusions mentioned above, for example.

For each toxicity criteria of each agent in the treatment plan of the treatment toxicity profile 395 corresponding to the disease/malady and candidate answer, the patient's corresponding attribute is compared to determine a score for the agent. That is, a plurality of comparisons to each toxicity criteria for the agent may be made and the combination of results used to perform a calculation of a toxicity score for the agent. For example, with reference to FIG. 4 hereafter, in the example of Cisplatin as an agent of a treatment for lung cancer, assume that the patient has a hearing grade of 3 and a creatinine clearance of 45. The hearing grade of 3 is at the high end of the range specified for Cisplatin and indicates a full exclusion (1.0) of the treatment for the particular patient. The creatinine clearance of 45 is part of a gradient range from 35 to 50 such that an exclusion value, ranging from 0 to 1.0 (1.0 being specified as a maximum exclusion value) would provide an exclusion value of 0.33. A decaying sum may be used to calculate a toxicity score of Cisplatin for this patient of (1.0)*1.0+(0.5)*0.33=1.165.

This agent toxicity scoring is done for each agent in the treatment plan/option to generate a separate agent toxicity score (or simply “agent score”) for each agent which may then be combined to generate a toxicity score for the treatment as a whole. Continuing with the example above, for example, assume that the combination treatment of Bevacizumab and Cisplatin has been evaluated and that the previous patient is 70 years old. It is known from above that their Cisplatin agent toxicity score is a 1.165. Because of the gradient range for Bevacizumab and age, their Bevacizumab score may be 0.4. Another decaying sum is used and their overall score for this combination regimen or treatment, i.e. Bevacizumab and Cisplatin, is (1.0)*1.165+(0.5)*0.4=1.365. From this scoring, it can be determined that Bevacizumab alone might be appropriate for this patient since it is only excluded at a rate of 0.4, however a combination treatment of Bevacizumab and Cisplatin is definitely not advisable due to the strong exclusion that Cisplatin contributes. Thus, for any particular treatment plan or option, there may be one or more agent toxicity scores associated with the treatment plan/option. These individual agent toxicity scores indicate, for each agent, the tolerance that the patient has for that particular agent in the treatment plan on an individual basis. In some cases, this agent toxicity score by itself (such as in the case of Cisplatin in the example above) may eliminate the treatment plan from further consideration due to a high level of toxicity or low level of tolerance by the particular patient.

The treatment toxicity scoring logic 393 combines the individual agent toxicity scores into a score for the treatment plan/option as a whole. This combination of agent toxicity scores may take into consideration the interaction of the particular agent with other agents in the treatment plan. For example, if one agent negatively interacts with another agent to cause particular side effects, these side effects are taken into consideration when calculating the toxicity score for the treatment plan as a whole. This may involve again comparing one or more patient attributes to attributes affected by the particular interaction of agents such that the scoring is decreased if the patient has particular patient attributes negatively affected by the interaction of the agents. Moreover, any particular desirable function or equation to correlate the scores of various agents into a final toxicity score for the particular treatment plan may be utilized. In one illustrative embodiment, for a treatment plan in which multiple agents are utilized, a decaying sum may be utilized to combine the agent toxicity scores as illustrated above.

It should be appreciated that in generating agent toxicity scores and/or treatment toxicity scores by the logic 392 and/or 393, patient preferences, as may be specified in the patient medical profiles 394, may be evaluated along with patient attributes and toxicity criteria of the agents of the treatment plan. For example, a patient may indicate that they are not interested in enduring radiation treatments, do not want to experience nausea, are willing to accept hair loss, are willing to travel more than 100 miles for treatment, or any of a plethora of other patient preferences that may be taking into consideration when scoring particular agents and/or treatments. Thus, if a treatment plan involves, as one of the agents, radiation treatment, for example, and the patient has indicated a desire to not undergo radiation treatment, then the treatment plan may be given a higher toxicity score or lower toxicity tolerance score than other treatment plans that do not involve radiation treatment. As another example, the patient may specify that they are willing to endure a particular level of toxicity (such as in the form of a toxicity score value that is a threshold tolerance of the patient) and if the treatment plan's toxicity level exceeds this level of toxicity, then the treatment plan has its score reduced so that it is not considered highly for recommendation purposes.

In some illustrative embodiments, a patient's preferences may be identified through an indication of level of concern about different potential side effects that various agents or treatments may cause. For example, a patient may indicate their level of concern for a side effect of “fatigue” with the levels being None (0), Minor (1), Moderate (2), and Severe (3). If the patient indicates a moderate level of concern for fatigue, the score for any agents that have fatigue listed as a side effect may be decreased (indicating the agent to be less favorable) by a factor of 2*(0.25)=0.5, for example. If the patient had indicated a severe level of concern for fatigue, the score for any agents having fatigue listed as a side effect may be decreased by a factor of 3*(0.25)=0.75. That is, each level of concern worse causes a larger exclusion for agents that have that side effect listed as being associated with that agent.

The treatment toxicity scores generated by the treatment toxicity scoring logic 393 may be returned to the hypothesis and evidence scoring stage 350, hypothesis generation stage 340, and/or the final confidence merging and ranking stage 370 to facilitate adjusting the scoring of candidate answers based on toxicity and patient tolerance, depending upon the particular implementation. Thus, while a candidate answer (treatment plan/option) may have been highly (or lowly) rated (based on confidence score) in response to the search of the corpus 347 or corpora 345, this scoring may be positively or negatively affected by the toxicity score associated with that particular candidate answer. For example, if the toxicity score is relatively low, or the toxicity tolerance score is relatively high, then the corresponding candidate answer's overall score combining confidence and toxicity/tolerance would be increased to more heavily favor the candidate answer for recommendation to the user. If the toxicity score is relatively high, or the toxicity tolerance score is relatively low, then the corresponding candidate answer's overall score combining confidence and toxicity/tolerance would be reduced to less heavily favor the candidate answer for recommendation to the user. As a result, the final confidence merging and ranking 370 may be affected by the influence of the toxicity scoring for the particular candidate answers (treatment plans/options).

The final answer, confidence, and toxicity score stage 380 outputs a graphical user interface to the user's client device that submitted the input question 310 to inform the user of the recommended treatment plan(s) for the disease/malady of the particular patient. This graphical user interface may output just the final candidate answer determined from the ranked listing of candidate answers generated by the operation of stages 350-370, may output the ranked listing of candidate answers, or a combination of a final answer and a ranked listing of other candidate answers. The graphical user interface may also provide, in association with the final answer and/or candidate answers, an indication of the toxicity score for each candidate answer. Moreover, the graphical user interface may include graphical user interface elements for selection by the user to drill down into the evidence in support of the treatment plan being a treatment plan for the disease/malady as obtained from the corpus 347 or corpora 345. In addition, the graphical user interface may include graphical user interface elements for drilling down into the reasoning behind the toxicity score calculated for the particular treatment plan of the candidate answers/final answer. For example, a user may drill down into the final answer to determine that the reason why the toxicity score is relatively low compared to the other candidate answers is because of the patient's attributes not falling within the ranges of toxicity criteria for the particular agents of the treatment plan. These toxicity criteria may be displayed in correlation with the patient's particular attribute values to show the correlation. This may be done in a graphical manner, for example, for each toxicity criteria of each agent so that the user can quickly identify where the patient falls with regard to the toxicity criteria of each agent. This again can be done for each candidate answer in the ranked list and/or the final answer. Thus, the user is given not only the recommendation to answer the original input question, but is further given the reasoning behind the recommendation and the evidential support for why the treatment is a valid treatment for the particular disease/malady as determined from the corpus 347 or corpora 345.

Thus, with the mechanisms of the illustrative embodiments, treatments are recommended for patients taking into account the patient's comorbidities on a per treatment and toxicity level. Using the mechanisms of the illustrative embodiments, the patient is more likely to get the best treatment that they can tolerate instead of a treatment that is recommended solely based on toxicity levels. Moreover, with the illustrative embodiments, the patient is more likely to get a treatment that meets some, if not all, of their preferences within the realm of toxicity and side effects.

FIG. 4 is an example diagram illustrating a treatment toxicity profile in accordance with one illustrative embodiment. FIG. 4 illustrates the treatment toxicity profile as being in a tabular spreadsheet format, however the illustrative embodiments are not limited to such. Any data format that facilitates the specification of toxicity criteria in association with agents of one or more treatment plans and potential patient attributes may be used without departing from the spirit and scope of the illustrative embodiments. For purposes of this description, it will be assumed that the treatment toxicity profile is a spreadsheet data file that may be customized with a properties file.

As shown in FIG. 4, the treatment toxicity profile 400 that is depicted is for specifying treatments for lung cancer. It should be appreciated that different treatment toxicity profiles may be generated for different diseases/maladies and/or combinations of treatments with different diseases/maladies. The treatment toxicity profile 400 includes entries 410 for different treatments and treatment agents. In this particular depicted example, each of the treatments listed comprises a single treatment agent, with the treatment agent being a particular drug. However, it should be appreciated that treatment entries 410 may comprise a plurality of treatment agents which may be listed in association with the particular treatment entry 410. In the depicted example, treatment entries 410 are represented as rows in the spreadsheet of the treatment toxicity profile 400.

A plurality of potential patient attributes are listed in columns 420-460 of the treatment toxicity profile 400. These represent patient attributes that are of particular concern when recommending a treatment for the particular disease/malady associated with the treatment toxicity profile 400. Thus, different treatment toxicity profiles may have different patient attributes 420-460 and different treatment entries 410. In some illustrative embodiments, the potential patient attributes in columns 420-460 may be standardized across treatment toxicity profiles 400 although the particular treatment entries 410 generally will not be and the toxicity criteria 470 associated with each of the treatment entries 410 and potential patient attributes 420-460 may be different depending upon the particular combination of treatment and patient attribute. The potential patient attributes 420-460 may be any attribute that can be represented as a numerical value or a value indicative of a “yes” or “no” entry, e.g., “1” if the attribute is present or “0” if the attribute is not present.

As touched upon above, each of the cells representing the correspondence between the treatment and the potential patient attribute, may have an associated toxicity criteria specified as a range, gradient, or fixed value. While the range values may be quantitative in nature, the values may represent a range of qualitative judgements of medical professionals. For example, if a range of 0-4 is specified, the value “0” may represent a worst case for the particular patient attribute while a value of “4” may represent a best case for the particular attribute, e.g., a value of 4 under creatinine clearance may indicate an excellent creatinine condition of the patient while a value of 0 may indicate a worst possible creatinine condition of the patient. An opposite approach may also be used where 4 is a worst case condition and 0 is a best case condition. Thus, if a toxicity criteria of 3-4 is indicated for a particular treatment with regard to creatinine clearance, then this may indicate that this treatment is not appropriate for patients that very bad or worst case creatinine conditions, for example. In other examples, the ranges or gradients may be actual values for the particular attribute, e.g., a creatinine scale may be established that has a minimum value of 0 and a maximum value of 100 and a range may be specified for a particular treatment of 35-50.

As shown in FIG. 4, in one illustrative embodiment, each toxicity criteria is specified as a triplet of values. A first value in the triplet specifies the range (start value to end value) of the particular patient attribute for which exclusion (or inclusion in some embodiments) of the treatment for the particular patient is applied. Alternatively, a single fixed value may be specified so that if the patient's attribute equals the single fixed value, then exclusion/inclusion is applied, e.g., if the value is a “1” then the patient has the particular attribute or if the value is a “0” then the patient does not have the particular attribute.

A second value in the triplet specifies a smoothing factor to maximum exclusion. For example, a value of “0” in the depicted example indicates a smooth gradient while a value of “1” denotes an immediate exclusion. To better understand this smoothing factor, consider that an exclusion value typically ranges from 0.0 to 1.0 on a gradient scale, although a range from 0.0 to 1.0 is not required and other exclusion ranges may be used without departing from the spirit and scope of the illustrative embodiments. Using an exclusion range of 0.0 to 1.0, if an agent or treatment is fully excluded, it is assigned a value of 1.0. For example, if an agent's range of values is 50-100 for a particular patient attribute, and one is using a “smoothing gradient” that indicated a 0, i.e. a smooth gradient, then a value of 50 will have an exclusion of 0, a value of 60 will have an exclusion of 0.2, a value of 75 will have an exclusion of 0.5, 80 will have an exclusion of 0.6 and 100 will have a value of 1.0. Immediate exclusions indicate situations that are contraindicated. For example, having a cardiac disease grade of 3 or worse indicates that the patient is immediately given the full exclusion of a 1.0 for the Cetuximab agent, for example, i.e. Cetuximab cannot be administered to that patient due to their cardiac disease grade.

The third value in the triplet specifies the maximum exclusion. This represents a maximum value for a toxicity score that is indicative of a full exclusion of the agent for the particular patient. It should be noted that while this is the maximum exclusion value for a particular agent, when calculating toxicity scores for agents and/or treatments as a whole, the maximum exclusion value may be exceeded, e.g., due to the aggregation of exclusions from a plurality of agents using a decaying sum, the resulting value may be greater than the maximum exclusion. For purposes of illustration, the maximum exclusion in the depicted examples is 1.0 meaning that toxicity scores for agents and/or treatments that equal or exceed a maximum exclusion score of 1.0 will generally be fully excluded from consideration as a treatment for the particular patient.

It should be appreciated that for any particular agent, the maximum exclusion value may be set lower than the actual maximum toxicity score for full exclusion of the agent from consideration for treatment of a patient. For example, if 1.0 represents a full exclusion of an agent from consideration for treatment, then for a particular agent the maximum exclusion value for a particular patient attribute may be set to a value less than 1.0, e.g., 0.9, indicating that the agent is strongly favored to be excluded, but is never fully excluded.

As discussed above, the particular patient attribute values of the patient in question are compared against the toxicity criteria of the treatments and agents being considered for recommendation as specified in the treatment toxicity profile 400 in order to generate a toxicity score for the particular agents and treatment plan. It should be appreciated that some patient attributes may be a proxy for other attributes or may be the same attribute but represented in different ways. For example, a creatinine clearance attribute is a proxy for a renal function metric and AST and ALT are proxies for hepatic function. The patient medical profiles 394 may have any number of patient attributes specified and thus, may have instances where more than one proxy for the same attribute are specified in the same patient medical profiles 394. As a result, double-counting can result if multiple like attributes are present, e.g., patient has grade 3 renal failure and poor creatinine clearance and as a result treatments where a renal function is a concern may be triggered based on both the renal failure grade and poor creatinine clearance being present.

In order to avoid such “double-counting”, the mechanisms of the illustrative embodiments may use groupings of like attributes when calculating agent and treatment scores by the toxicity scoring engine 390. That is, data structures may be specified in, or in association with, the toxicity scoring engine 390 to specify which potential patient attributes are referencing the same overall attribute, i.e. identifies proxies for a potential patient attribute, such that these are grouped together. When multiple such proxies are found in a patient medical profile 394, a grouping algorithm is implemented to group the values associated with these proxies. The grouping algorithm may take many different forms depending upon the particular implementation. For example, one grouping algorithm may select the worst calculated toxicity score of the proxies, e.g., the highest calculated score across the group of proxies. Another grouping algorithm may select the best calculated toxicity score of the proxies in the group, e.g., a lowest score across the group. Yet another grouping algorithm may use a decaying algorithm that starts with the worst score and adds additional scores using a decaying sum. Another grouping algorithm may utilize an ordered grouping in which a score is applied based on attribute preference regardless of other scores. Still further, an ordered decaying grouping algorithm may be utilized which starts with a preferred attribute and applies other attributes using a decaying sum by order preference. Moreover, a simple average of the calculated scores for the proxies may be utilized. Any grouping algorithm that takes a group of proxy attributes and combines them to generate a value for a single attribute may be used without departing from the spirit and scope of the illustrative embodiments.

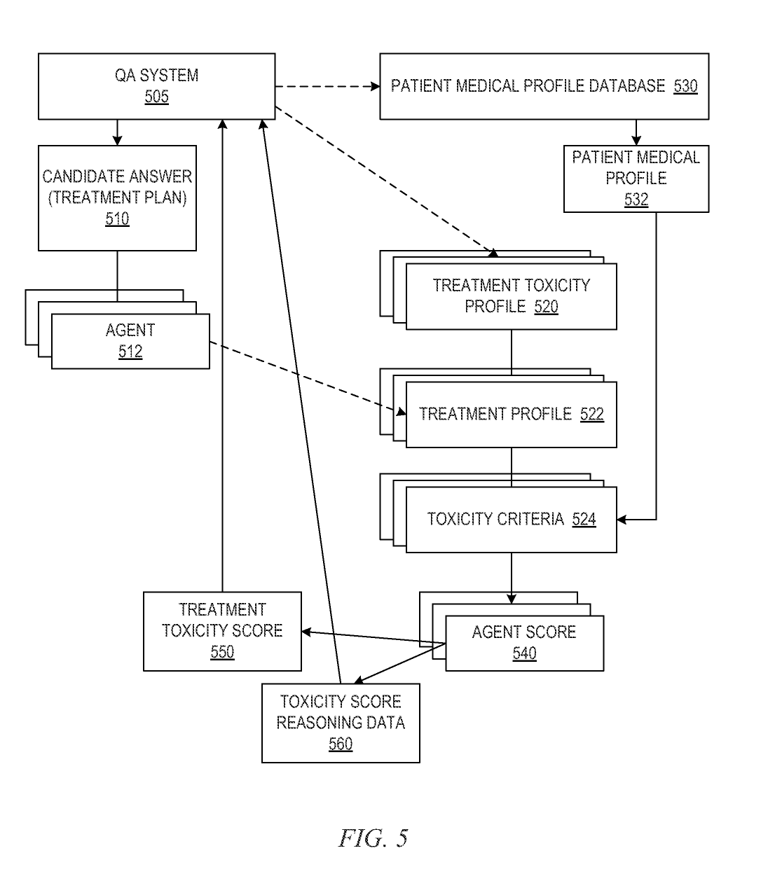

FIG. 5 is an example block diagram outlining an operation of a toxicity scoring engine in accordance with one illustrative embodiment. The operation shown in FIG. 5 is for a single candidate answer generated by a QA system 505 in response to an input question requesting a recommendation for treatment of a specified disease/malady of a particular patient.

As shown in FIG. 5, the candidate answer 510 is analyzed to break down the treatment plan specified in the candidate answer 510 into constituent agents 512. The candidate answer 510 is further used to retrieve one or more corresponding treatment toxicity profiles 520, such as from a treatment toxicity profile database (not shown), that include treatment profiles 522 and corresponding toxicity criteria 524. The treatment profiles 522 are selected from the applicable treatment toxicity profiles 520 based on the particular constituent agents 512 identified from the candidate answer 510.

A particular patient medical profile 532 for the specified patient is retrieved from the patient medical profile database 530 and used as a basis for inputting important patient attributes for comparison with the toxicity criteria 524 of the selected treatment profiles 522 from the treatment toxicity profiles 520. The comparison of the important patient attributes from the patient medical profile 532 with the toxicity criteria 524 results in an agent score 540 for the particular agent 512. As mentioned above, this may be done for each agent 512 such that a plurality of agent scores 540 are generated for the treatment plan specified in the candidate answer 510. These agent scores 540 may be calculated using a decaying sum, for example, of the various toxicity criteria comparison scores. The agent scores 540 are then combined to generate a treatment toxicity score 550 and corresponding patient clinical data and toxicity score reasoning information 560. The treatment toxicity score 550 and patient clinical data and toxicity score reasoning information 560 are returned for modifying the confidence score associated with the candidate answer 510. The QA system may then generate a ranked listing of candidate answers based on the modified confidence scores and generate and output a graphical user interface as previously described above to inform the submitter of the original input question of the recommended treatment and the reasoning behind the recommendation.

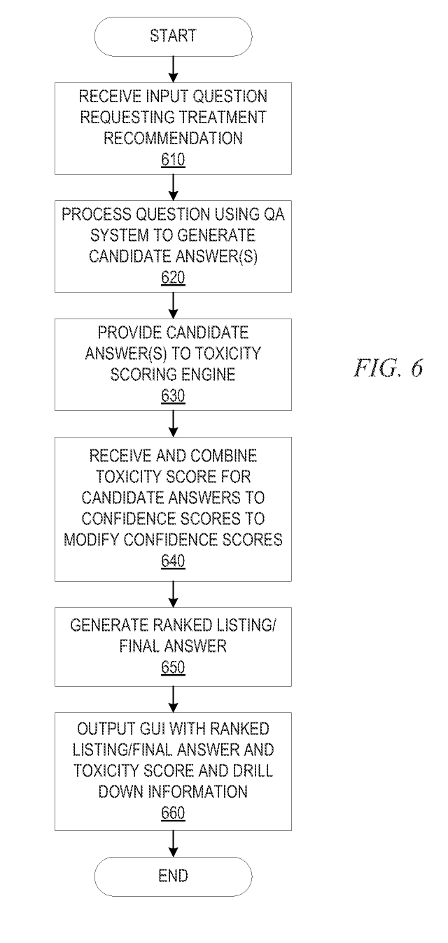

FIG. 6 is a flowchart outlining an example operation of a question answering system in accordance with one illustrative embodiment. As shown in FIG. 6, the operation starts with receiving an input question requesting a recommendation of a treatment plan for a particular patient and the patient's disease/malady (step 610). The input question is processed by the QA system pipeline, by parsing and analyzing the question, generating one or more queries that are applied against the corpus to generate one or more candidate answers specifying potential treatment plans for the disease/malady (step 620). The candidate answers are provided to a toxicity scoring engine to score the toxicity of the candidate answer relative to the tolerance of the particular patient (step 630). The resulting toxicity scores for the candidate answers are combined with the confidence scores for the candidate answers to generate modified scores for the candidate answers (step 640). A ranked listing of candidate answers is generated and a final answer to the input question is selected (step 650). The final answer and/or ranked listing of candidate answers is output via a graphical user interface that further includes information regarding the toxicity scores of the candidate answers and having graphical user interface elements for drilling down into the evidence and reasoning for the candidate answer scoring and toxicity scoring (step 660). The operation then terminates.

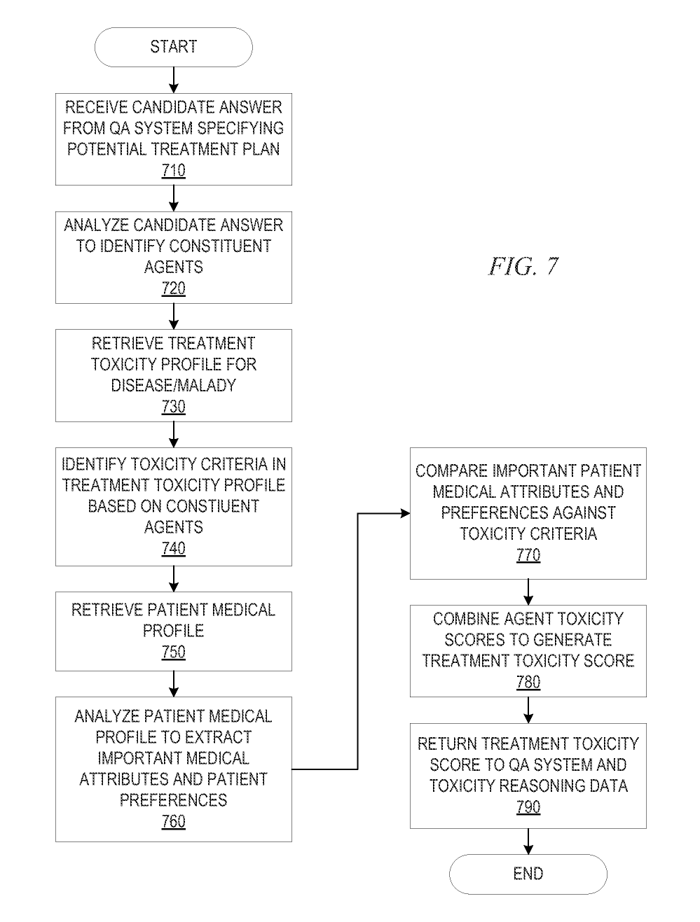

FIG. 7 is a flowchart outlining an example operation of a toxicity scoring engine in accordance with one illustrative embodiment. The operation in FIG. 7 starts with receiving a candidate answer from the QA system with the candidate answer specifying a potential treatment plan for a disease/malady of a particular patient (step 710). The candidate answer is analyzed to identify the various one or more constituent agents that make up the potential treatment plan specified in the candidate answer (step 720). In addition, a treatment toxicity profile is retrieved for the disease/malady for which a recommended treatment is desired (step 730).

The potential treatment plan and its constituent agents are identified in the treatment toxicity profile to thereby identify the toxicity criteria associated with the constituent agent for various potential patient attributes (step 740). A patient medical profile for the particular patient is retrieved (step 750) and analyzed to extract important patient medical attributes and patient preferences (step 760). The important patient medical attributes and patient preferences are compared against corresponding toxicity criteria for the agents to determine an agent toxicity score (step 770). The agent toxicity scores are then combined to generate a treatment toxicity score for the entire treatment taking into consideration agent interactions and patient preferences (step 780). The resulting treatment toxicity score is then returned to the QA system which modifies a score associated with the candidate answer based on the treatment toxicity score associated with the candidate answer (step 790). The operation then terminates for this candidate answer but may be repeated for each candidate answer submitted to the toxicity scoring engine by the QA system. It should be appreciated that, as discussed above, based on the modified score, the QA system generates a ranked listing of candidate answers and/or a final answer indicative of a recommended treatment which is then output to the user that submitted the original input question via a graphical user interface.

Thus, the illustrative embodiments provide mechanisms for generating recommended treatments for medical diseases/maladies based on determined toxicity levels and a particular patient's tolerance to the toxicity of the treatments. A ranked listing of potential treatments for the particular patient's disease/malady may be generated based on the toxicity profiles of the treatment as a whole as well as the individual agents that are constituents of the treatment. The patient's preferences for tolerating toxicity levels is also taken into consideration. The mechanisms work in conjunction with a QA system and operate to evaluate candidate answers indicating potential treatment plans with regard to toxicity such that the scoring associated with the candidate answers is modified based on the toxicity level and patient toxicity tolerance. A graphical user interface is provided that informs the user of the recommended treatment(s), their toxicity scores, and the underlying reasoning for the recommendation and toxicity scoring. Thus, users are given treatment recommendations tailored to a particular patient based on toxicity of the treatment to the particular patient and the patient's ability/desire to tolerate the treatment, as well as reasoning information that may be reviewed to determine the reasoning behind the recommendation.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, for outputting a treatment recommendation for a medical malady, the method comprising:
receiving, by the data processing system, an input specifying a medical malady of a specified patient;
determining, by the data processing system, one or more constituent agents of a potential treatment for the specified medical malady of the specified patient;
retrieving, by the data processing system, a treatment toxicity profile corresponding to the medical malady;
calculating, by the data processing system, a treatment toxicity score for the potential treatment based on a comparison of patient medical attributes of the specified patient to toxicity criteria associated with the one or more constituent agents identified in the treatment toxicity profile; and
outputting, by the data processing system, a treatment recommendation based on the treatment toxicity score.

2. The method of claim 1, wherein calculating the treatment toxicity score comprises:
determining, by the data processing system, for each of the one or more constituent agents of the potential treatment, one or more toxicity criteria corresponding to one or more potential patient attributes based on the treatment toxicity profile;
retrieving, by the data processing system, a patient medical profile identifying patient medical attributes of the specified patient;
determining, by the data processing system, an agent toxicity score based on a comparison of the patient medical attributes to the one or more toxicity criteria; and
combining, by the data processing system, agent toxicity scores for the one or more constituent agents to generate the treatment toxicity score.

3. The method of claim 1, wherein calculating the treatment toxicity score comprises:
determining, by the data processing system, an agent toxicity score based on a the patient tolerance to the toxicity criteria associated with the one or more constituent agents; and
combining, by the data processing system, agent toxicity scores for the one or more constituent agents to generate the treatment toxicity score.

4. The method of claim 1, wherein:
the treatment toxicity profile comprises one or more treatment entries for one or more potential treatments of the medical malady,
each treatment entry comprises one or more constituent agent entries specifying a corresponding constituent agent used in the potential treatment associated with the treatment entry, and
each constituent agent entry comprises one or more toxicity criteria values associated with one or more predetermined patient medical attributes.

5. The method of claim 4, wherein the one or more toxicity criteria values associated with one or more predetermined patient medical attributes comprises, for each toxicity criteria value in the one or more toxicity criteria values, a first element specifying a fixed value or range of values for a corresponding patient medical attribute in which the corresponding constituent agent is considered to be toxic to a patient having an associated predetermined patient medical attribute corresponding to the toxicity criteria value, and a second element specifying a smoothing factor indicating a gradient for exclusion of a patient for treatment by the corresponding constituent agent.

6. The method of claim 1, further comprising:
generating the treatment toxicity profile by performing natural language processing on a corpus of electronic documents specifying potential treatments for the medical malady and corresponding toxicity criteria for the potential treatments.

7. The method of claim 1, wherein the treatment toxicity score for the potential treatment is further calculated based on a comparison of patient preferences specifying a level of acceptable toxicity for the patient to the toxicity criteria associated with the one or more constituent agents identified in the treatment toxicity profile.

8. The method of claim 1, further comprising:
receiving an indication of the potential treatment for the specified medical malady of the specified patient as a candidate answer generated by a Question Answering (QA) system in response to an input question requesting a treatment recommendation for the specified medical malady.

9. The method of claim 8, wherein outputting the treatment recommendation based on the treatment toxicity score comprises:
modifying a confidence score associated with the candidate answer based on the treatment toxicity score;
ranking the candidate answer relative to other candidate answers to the input question based on the modified confidence score and confidence scores of the other candidate answers to generate a ranked listing of candidate answers;
selecting at least one candidate answer from the ranked listing of candidate answers to be a treatment recommendation; and
outputting the treatment recommendation to a computing device associated with a submitter of the input question.

10. The method of claim 9, wherein the output of the treatment recommendation comprises information identifying the treatment toxicity score and supporting evidence for the treatment recommendation.

11. A computer program product comprising a computer readable storage medium having a computer readable program stored therein, wherein the computer readable program, when executed on a computing device, causes the computing device to:
receive an input specifying a medical malady of a specified patient;
determine one or more constituent agents of a potential treatment for the specified medical malady of the specified patient;
retrieve a treatment toxicity profile corresponding to the medical malady;
calculate a treatment toxicity score for the potential treatment based on a comparison of patient medical attributes of the specified patient to toxicity criteria associated with the one or more constituent agents identified in the treatment toxicity profile; and
output a treatment recommendation based on the treatment toxicity score.

12. The computer program product of claim 11, wherein calculating the treatment toxicity score comprises:
determining, by the data processing system, for each of the one or more constituent agents of the potential treatment, one or more toxicity criteria corresponding to one or more potential patient attributes based on the treatment toxicity profile;
retrieving, by the data processing system, a patient medical profile identifying patient medical attributes of the specified patient;
determining, by the data processing system, an agent toxicity score based on a comparison of the patient medical attributes to the one or more toxicity criteria; and
combining, by the data processing system, agent toxicity scores for the one or more constituent agents to generate the treatment toxicity score.

13. The computer program product of claim 11, wherein calculating the treatment toxicity score comprises:
determining, by the data processing system, an agent toxicity score based on the patient tolerance to the toxicity criteria associated with the one or more constituent agents; and
combining, by the data processing system, agent toxicity scores for the one or more constituent agents to generate the treatment toxicity score.

14. The computer program product of claim 11, wherein:
the treatment toxicity profile comprises one or more treatment entries for one or more potential treatments of the medical malady,
each treatment entry comprises one or more constituent agent entries specifying a corresponding constituent agent used in the potential treatment associated with the treatment entry, and
each constituent agent entry comprises one or more toxicity criteria values associated with one or more predetermined patient medical attributes.

15. The computer program product of claim 14, wherein the one or more toxicity criteria values associated with one or more predetermined patient medical attributes comprises, for each toxicity criteria value in the one or more toxicity criteria values, a first element specifying a fixed value or range of values for a corresponding patient medical attribute in which the corresponding constituent agent is considered to be toxic to a patient having an associated predetermined patient medical attribute corresponding to the toxicity criteria value, and a second element specifying a smoothing factor indicating a gradient for exclusion of a patient for treatment by the corresponding constituent agent.

16. The computer program product of claim 11, further comprising:
generating the treatment toxicity profile by performing natural language processing on a corpus of electronic documents specifying potential treatments for the medical malady and corresponding toxicity criteria for the potential treatments.

17. The computer program product of claim 11, wherein the treatment toxicity score for the potential treatment is further calculated based on a comparison of patient preferences specifying a level of acceptable toxicity for the patient to the toxicity criteria associated with the one or more constituent agents identified in the treatment toxicity profile.

18. The computer program product of claim 11, further comprising:
receiving an indication of the potential treatment for the specified medical malady of the specified patient as a candidate answer generated by a Question Answering (QA) system in response to an input question requesting a treatment recommendation for the specified medical malady.

19. The computer program product of claim 18, wherein outputting the treatment recommendation based on the treatment toxicity score comprises:
modifying a confidence score associated with the candidate answer based on the treatment toxicity score;
ranking the candidate answer relative to other candidate answers to the input question based on the modified confidence score and confidence scores of the other candidate answers to generate a ranked listing of candidate answers;
selecting at least one candidate answer from the ranked listing of candidate answers to be a treatment recommendation; and
outputting the treatment recommendation to a computing device associated with a submitter of the input question.

20. An apparatus comprising:
a processor; and
a memory coupled to the processor, wherein the memory comprises instructions which, when executed by the processor, cause the processor to:
receive an input specifying a medical malady of a specified patient;
determine one or more constituent agents of a potential treatment for the specified medical malady of the specified patient;
retrieve a treatment toxicity profile corresponding to the medical malady;
calculate a treatment toxicity score for the potential treatment based on a comparison of patient medical attributes of the specified patient to toxicity criteria associated with the one or more constituent agents identified in the treatment toxicity profile; and
output a treatment recommendation based on the treatment toxicity score.
